(19) United States
(12) Patent Application Publication
(10) Pub. No.: US 2009/0186649 A1
(43) Pub. Date: Jul. 23, 2009

(54) COMMUNICATION TERMINAL AND MOBILE COMMUNICATION SYSTEM

(75) Inventors: Tomonori Sugiyama, Shizuoka (JP); Naohiro Matsushita, Shizuoka (JP); Jun Yaginuma, Shizuoka (JP); Fumio Suzuki, Chiba (JP); Kazuhiko Takano, Chiba (JP); Nobunao Ishii, Tokyo (JP)

Correspondence Address: TUROCY & WATSON, LLP, 127 Public Square, 57th Floor, Key Tower, CLEVELAND, OH, 44114, US

(73) Assignees: TOSHIBA TEC KABUSHIKI KAISHA, Tokyo (JP); FUJIKURA LTD, Tokyo (JP)

(21) Appl. No.: 12/354,189

(22) Filed: Jan. 15, 2009

(30) Foreign Application Priority Data
Jan. 18, 2008 (JP) 2008-9712

(51) Int. Cl. H04B 7/00

(52) U.S. Cl. 455/523

(57) ABSTRACT

A mobile communication terminal according to the present invention has a leaky transmission line whose radiation direction faces opposite a radiation direction of a part or a whole of the leaky transmission line of a wireless base station, as at least a part of an antenna element, connected to the communication terminal. Here, preferably, when a difference in angle between the radiation directions falls within the range between 180±7.5 degrees, the radiation directions are considered to face opposite each other. With this configuration, even when the leaky transmission line of the wireless base station has a curved line portion, a curved portion or the like, it is possible to ensure satisfactory communications with the wireless base station without a complicated configuration of the system but by a simple process to build the system.

### CROSS-REFERENCE TO RELATED APPLICATION

This application claims, under 35 USC 119, priority of Japanese Application No. 2008-9712 filed Jan. 18, 2008.

### BACKGROUND OF THE INVENTION

1. Field of the Invention

The present invention relates to a communication terminal and a mobile communication system. More particularly, the invention is suitably applied to a system in which a leaky transmission line is used as an antenna for a wireless base station.

2. Description of Related Art

Conventionally, a system, for example, has been studied in which, in a mobile communication system where a mobile communication terminal moves in a predetermined route, the mobile communication terminal performs data communications through a leaky transmission line. For example, in communications between a train and a trackside device and communications between an automated guided vehicle and its control station, leaky transmission lines connected to wireless base stations such as the trackside device and the control station are available.

When a leaky transmission line is laid by being suspended, it is fixed at intervals and thus is laid in a curved shape by its own weight. When the leaky transmission line is so laid as to bypass obstructions, portions of the leaky transmission line may be laid in a curved shape. When a mobile communication terminal moves along the leaky transmission line, the coupling between the antenna of the mobile communication system and the leaky transmission line is degraded at such curved line portions.

To overcome such a disadvantage, there is a technology disclosed in Japanese Patent Laid-open No. 04-230131 as a conventional technology. In the technology disclosed in this patent publication, as shown in FIG. 15, position detection beacons 8 are arranged at predetermined places within tracks 6, and a moving object 3 receives, with a directivity switching device 7 for a mobile station antenna 4, information on the position of the moving object 3 detected by the position detection beacons 8. The directivity switching device 7 switches the direction of a beam from the mobile station antenna 4 according to the position information of the moving object 3, and thus a decrease in received electric field of the moving object 3 is prevented even in the curved portions of the leaky transmission line (leaky coaxial cable: LCX) 1.

In the technology disclosed in the above-described patent publication, however, it is necessary to arrange the position detection beacons 8 at all the curved portions of the leaky transmission line 1, and thus the installation of the position detection beacons 8 is required. Moreover, it is also necessary that the moving object be provided with the directivity switching device 7, which receives position information and switches the direction of a beam from the mobile station antenna 4. This results in the complicated configuration of a mobile communication system and poor workability in building the system.

### SUMMARY OF THE INVENTION

In view of the foregoing, it is an object of the present invention to provide a communication terminal and a mobile communication system that ensures satisfactory communications with the communication terminal without a complicated configuration of the system but by a simple process to build the system, even when a leaky transmission line has a curved line portion, a curved portion or the like.

According to one aspect of the present invention, when a communication terminal communicates with a base station that has, as an antenna, a leaky transmission line including a curved portion in at least a part thereof or a leaky transmission line including two linear portions extending in different directions in at least a part thereof, the communication terminal relatively moves in parallel to the leaky transmission line of the base station, and the communication terminal has a leaky transmission line whose radiation direction faces opposite a radiation direction of a part or a whole of the leaky transmission line of the base station, as at least a part of an antenna element, connected to the communication terminal.

According to another aspect of the present invention, there is provided a mobile communication system including: a first communication terminal that has, as an antenna, a leaky transmission line including a curved portion in at least a part thereof or a leaky transmission line including two linear portions extending in different directions in at least a part thereof; and a second communication terminal that communicates with the first communication terminal, that relatively moves in parallel to the leaky transmission line of the first communication terminal and that is provided according to the above aspect of the present invention.

With a communication terminal and a mobile communication system of the present invention, it is possible to ensure satisfactory communications with a base station without a complicated configuration of the system but by a simple process to build the system, even when the leaky transmission line of the wireless base station has a curved line portion, a curved portion or the like.

### BRIEF DESCRIPTION OF THE DRAWINGS

FIG. 1 is an illustrative diagram showing the configuration of a mobile communication system according to a first embodiment.

FIG. 2 is illustrative diagrams showing a communication characteristic when the directivities of two leaky transmission lines used in communications face opposite to each other.

FIG. 3 is illustrative diagrams showing a communication characteristic when the directivities of two leaky transmission line portions used in communications do not face opposite to each other.

FIG. 4 is illustrative diagrams showing a communication characteristic when a leaky transmission line and a transmit/receive antenna are used in communications.

FIG. 5 is illustrative diagrams showing a coupling loss when two leaky transmission line portions used in communications are parallel to each other.

FIG. 6 is illustrative diagrams showing a coupling loss when only a displacement of 7.5 degrees occurs with respect to the parallelism between the two leaky transmission line portions used in communications.

FIG. 7 is a diagram showing the characteristic and the measurement result of the directivity of a leaky transmission line at a predetermined frequency.

FIG. 8 is illustrative diagrams showing a coupling loss when only a displacement of 12.5 degrees occurs with respect to the parallelism between the two leaky transmission line portions used in communications.

FIG. 9 is an illustrative diagram showing the configuration of a mobile communication system according to a second embodiment.

FIG. 10 is an illustrative diagram showing the configuration of a mobile communication system according to a third embodiment.

FIG. 11 is an illustrative diagram showing the configuration of a mobile communication system according to a fourth embodiment.

FIG. 12 is an illustrative diagram showing the configuration of a mobile communication system according to a fifth embodiment.

FIG. 13 is an illustrative diagram showing the configuration of a mobile communication system according to a sixth embodiment.

FIG. 14 is an illustrative diagram schematically showing the configuration of a moving object according to a seventh embodiment.

FIG. 15 is an illustrative diagram showing the configuration of a mobile communication system according to a first embodiment of the patent publication related to a conventional technology.

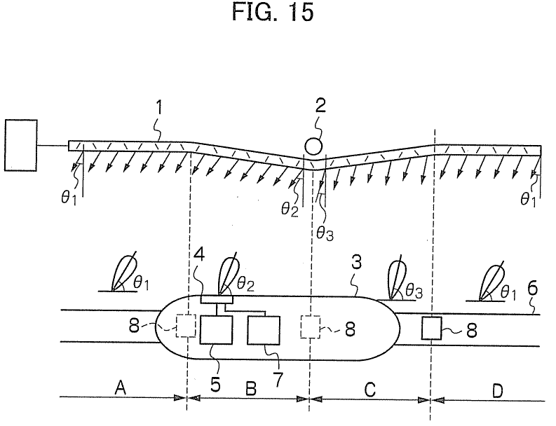

### DESCRIPTION OF THE PREFERRED EMBODIMENTS

### (A) A First Embodiment

A communication terminal and a mobile communication system according to a first embodiment of the present invention will be described below with reference to the accompanying drawings.

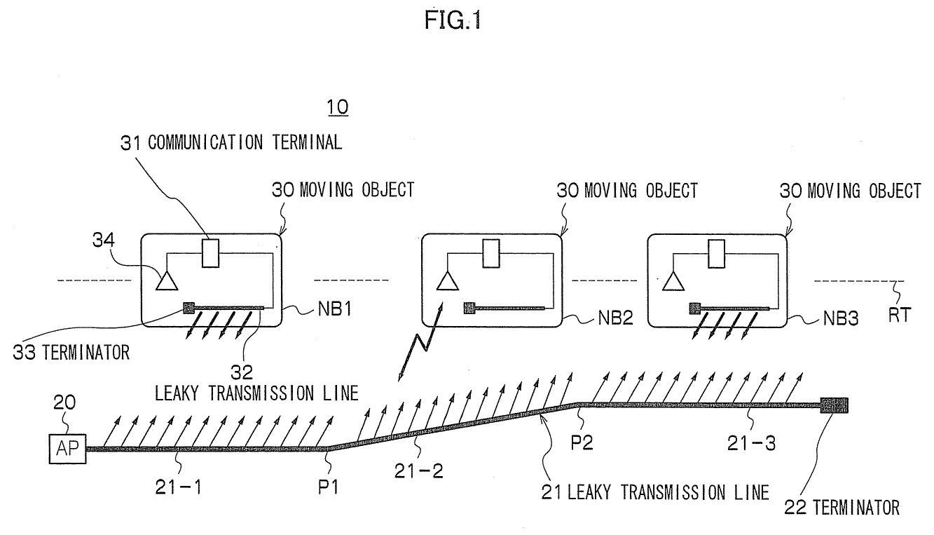

FIG. 1 shows the configuration of the mobile communication system of the first embodiment.

In FIG. 1, the mobile communication system 10 of the first embodiment has a wireless base station (access point: AP) 20 and a moving object 30.

The wireless base station 20 has a leaky transmission line 21 as an antenna; the leaky transmission line 21 is terminated by a terminator (a termination resistor) 22. In the first embodiment, the leaky transmission line 21 is divided by two bent points P1 and P2 into three portions 21-1 to 21-3. The leaky transmission line portions 21-1 and 21-3 extend parallel to the linear movement path RT of the moving object 30; the intermediate leaky transmission line portion 21-2 extends obliquely with respect to the linear movement path RT of the moving object 30.

The moving object 30 moves linearly along the movement path RT. The moving object 30 has a communication terminal 31 that communicates with the wireless base station 20, a leaky transmission line 32 functions as a first antenna, a terminator (a termination resistor) 33 for terminating the leaky transmission line 32 and a transmit/receive antenna 34 functions as a second antenna.

The direction in which the leaky transmission line 32 extends from the communication terminal 31 is opposite to the direction in which the leaky transmission line 21 (especially the leaky transmission line portions 21-1 and 21-3) extends from the wireless base station 20. Although these extension directions are opposite, the leaky transmission line 32 and the leaky transmission line portions 21-1 and 21-3 are parallel to each other. Thus, the direction of radiation of the leaky transmission line 32 faces opposite the direction of radiation of the leaky transmission line portions 21-1 and 21-3 but does not face opposite the direction of radiation of the intermediate leaky transmission line portion 21-2. For example, as the leaky transmission line 32 and the leaky transmission line 21, leaky coaxial cables having different lengths but the same properties are used.

The transmit/receive antenna 34 is used an antenna other than the leaky transmission lines. For example, the transmit/receive antenna 34 is used an antenna such as a dipole antenna, a Yagi antenna or a planar antenna. The transmit/receive antenna 34 has a directivity (that may be a high directivity, a low directivity or an isotropy) corresponding to the direction of radiation of the intermediate leaky transmission line portion 21-2. Specifically, the transmit/receive antenna 34 preferably has a directivity in which the transmit/receive antenna 34 has a stronger coupling than that of the leaky transmission line 32 when the moving object 3 is positioned in the vicinity of the intermediate leaky transmission line portion 21-2.

The communication terminal 31 performs data communications, and in addition, the communication terminal 31 has a diversity circuit internally. The diversity circuit may be a selective diversity circuit that activates either of the leaky transmission line 32 and the transmit/receive antenna 34 according to, for example, their received levels. The diversity circuit may be a combination diversity circuit that combines the received levels of the leaky transmission line 32 and the transmit/receive antenna 34 in a predetermined ratio (for example, the ratio of half).

The moving object 30 is assumed to be positioned in the vicinity NB1 of the first portion 21-1 of the leaky transmission line 21. In this case, in the moving object 30, the leaky transmission line 32 that faces opposite the direction of radiation of the leaky transmission line portion 21-1 effectively functions. The leaky transmission line portion 21-1 and the transmit/receive antenna 34 can be coupled to each other, too. However, such a coupling is lower than the coupling between the leaky transmission line portion 21-1 and the leaky transmission line 32, the radiation directions of which face opposite each other.

The moving object 30 is assumed to be positioned in the vicinity NB2 of the second portion 21-2 of the leaky transmission line 21. In this case, in the moving object 30, the direction of radiation of the leaky transmission line 32 does not face opposite the direction of radiation of the leaky transmission line portion 21-2, and thus the coupling between the leaky transmission line portion 21-2 and the transmit/receive antenna 34 functions more effectively.

The moving object 30 is assumed to be positioned in the vicinity NB3 of the third portion 21-3 of the leaky transmission line 21. In this case, in the moving object 30, the leaky transmission line 32 that faces opposite the direction of radiation of the leaky transmission line portion 21-3 effectively functions. The leaky transmission line portion 21-3 and the transmit/receive antenna 34 can be coupled to each other, too. However, such a coupling is lower than the coupling between the leaky transmission line portion 21-3 and the leaky transmission line 32, the radiation directions of which face opposite each other.

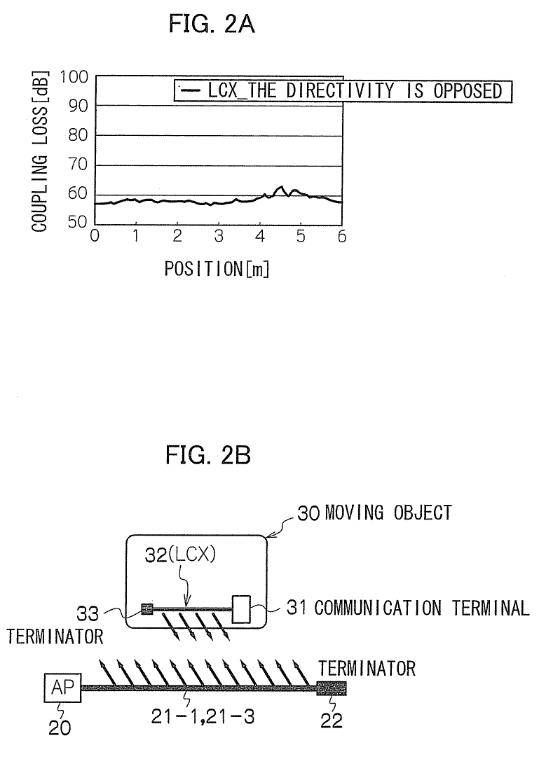

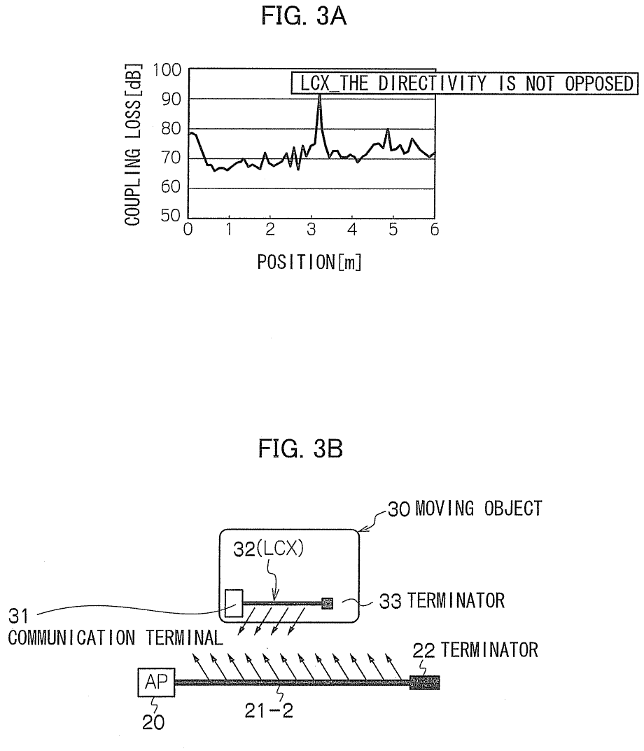

FIGS. 2(A) and 2(B) show a coupling loss (see FIG. 2(A)) when the radiation directions of the leaky transmission line 21-1 or 21-3 and the leaky transmission line 32 used in communications are opposite to each other (when they face opposite each other) (see FIG. 2(B)). FIGS. 3(A) and 3(B) show a coupling loss (see FIG. 3(A)) when the radiation directions of the leaky transmission line 21-2 and the leaky transmission line 32 used in communications are not opposite to each other (when they do not face opposite each other) (see FIG. 3(B)).

When the radiation directions of the leaky transmission lines used in communications are opposite to each other (when their directivities face opposite each other), the received level of the communication terminal 31 is high and the variations of the received level is few corresponding to the distance from the wireless base station 20. In contrast, when the radiation directions of the leaky transmission lines used in communications are not opposite to each other (when their directivities do not face opposite each other), the received level of the communication terminal 31 is low, and moreover, the variations of the received level is large corresponding to the distance from the wireless base station 20 and the communication terminal 31 is more likely to be affected by external noise.

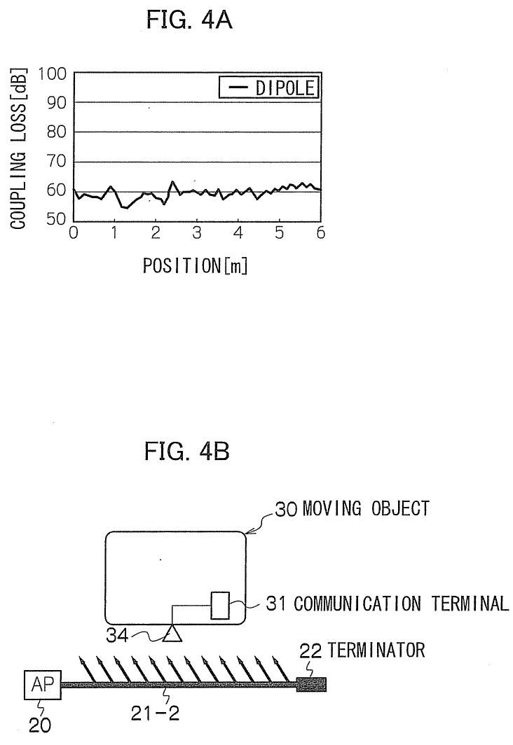

FIGS. 4(A) and 4(B) show a coupling loss (see FIG. 4(A)) when the leaky transmission line 21-2 and the transmit/receive antenna 34 are used in communications (when they face opposite each other) (see FIG. 4(B)).

When this case is compared with the case where the radiation directions of the leaky transmission line 21-1 or 21-3 and the leaky transmission line 32 used in communications are opposite to each other (see FIGS. 2(A) and 2(B)), in the former case, the received level of the communication terminal 31 is substantially similar or less and the variations of the received level is a little larger than the latter case. In contrast, when this case is compared with the case where the radiation directions of the leaky transmission line 21-2 and the leaky transmission line 32 used in communications are not opposite to each other (see FIGS. 3(A) and 3(B)), it is found that in the former case, the received level of the communication terminal 31 is significantly improved and variations in the received level are reduced.

The following will be understood from these illustrative diagrams. When the moving object 30 is positioned in the vicinity NB1 of the first portion 21-1 or in the vicinity NB3 of the third portion 21-3 of the leaky transmission line 21, in the moving object 30, the leaky transmission line 32 functions more effectively than the transmit/receive antenna 34. When the moving object 30 is positioned in the vicinity NB2 of the second portion 21-2 of the leaky transmission line 21, in the moving object 30, the transmit/receive antenna 34 functions more effectively than the leaky transmission line 32.

Although the above description mentions that the leaky transmission line 21-1 or 21-3 and the leaky transmission line 32 are parallel to each other, the term “parallel” used in the first embodiment means not only that the angle formed between the leaky transmission line 21-1 or 21-3 and the leaky transmission line 32 is 180 degrees (which is given with the extension directions taken into account) but also that the angle falls within the range between 180±7.5 degrees. In other words, the angle formed between the leaky transmission line 21-2 and the leaky transmission line 32 falls outside such a range. The reason why the above-mentioned angle range is regarded as “parallel” will be described below. It is assumed that the radiation directions of the leaky transmission line portion and the leaky transmission line in parallel face opposite each other. Specifically, when the difference in angle between the directions in which radio waves are radiated from the leaky transmission line portion and the leaky transmission line in parallel falls within the range between 180±7.5 degrees, it is assumed that the directions face opposite each other.

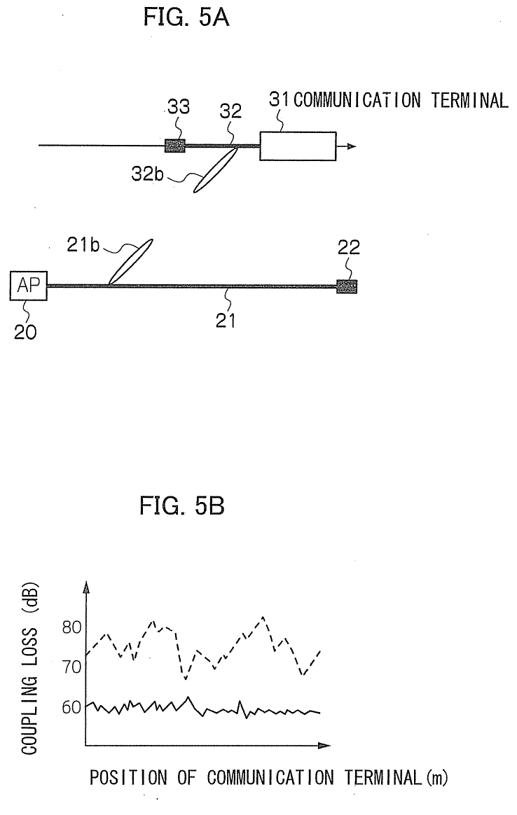

FIG. 5(A) shows a case where the leaky transmission line 32 connected to the communication terminal 31 moves in parallel to the leaky transmission line 21 connected to the wireless base station 20. FIG. 5(B) shows a coupling loss indicating the ease of communication in the case of FIG. 5(A), with the movement distance shown in the horizontal axis. In FIG. 5(A), reference numerals 21b and 32b represent electromagnetic beams. For example, the coupling loss Lc is calculated by the following equation (1), where Pin represents a power incident to the leaky transmission line 21 connected to the wireless base station 20 and Pout represents an output power from the leaky transmission line 32 connected to the communication terminal 31.

Lc=10 Log(Pout/Pin) (1)

The leaky transmission lines (LCX) 21 and 32 have a narrow directivity in which its half-value width is five degrees. Thus, it is possible to eliminate an electromagnetic beam or the like (for example, unnecessary noise) coming from outside the angle range of this directivity. Consequently, as indicated by a solid line shown in FIG. 5(B), a coupling loss with respect to the position of the communication terminal 31 is about 60 dB without significant variations. If the antenna connected to the communication terminal 31 is an isotropic dipole antenna and it is located at an area where an unnecessary reflected beam comes from the surface of a wall or the like, stable communications cannot be achieved due to variations in coupling loss. In this case, for example, the coupling loss falls off about 80 dB (see a broken line shown in FIG. 5(B)).

Now consider a case where the parallelism between the leaky transmission line 21 connected to the wireless base station 20 and the leaky transmission line 32 connected to the communication terminal 31 is degraded.

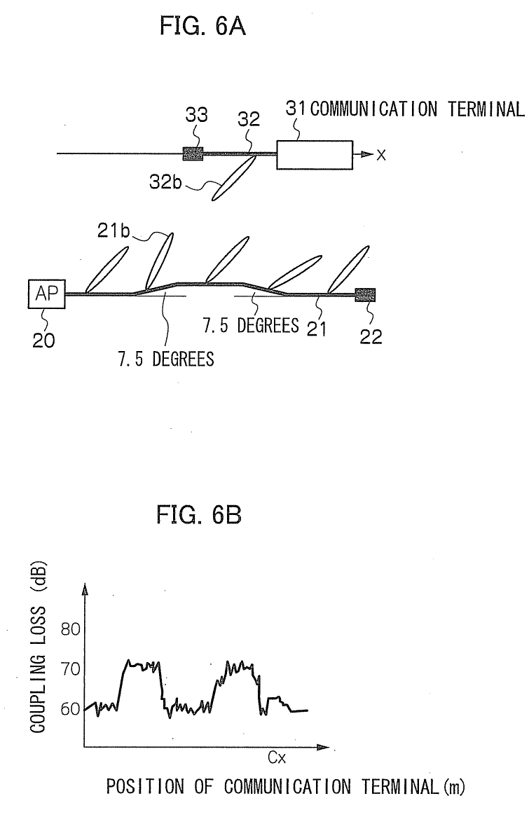

FIG. 6(A) shows a case where only a displacement of 7.5 degrees occurs partly with respect to the parallelism between the leaky transmission lines 21 and 32. Since in a portion where the parallelism is degraded, electromagnetic beams from the leaky transmission lines 21 and 32 do not face opposite each other, it can be expected that the coupling loss is increased. FIG. 6(B) shows the measurement result of the coupling loss with respect to the position of the communication terminal 31 when only a displacement of 7.5 degrees occurs partly with respect to the parallelism between the leaky transmission lines 21 and 32. FIG. 6(B) shows that the degraded parallelism causes the coupling loss to be increased by about 10 dB, that is, the quality of the communications is degraded.

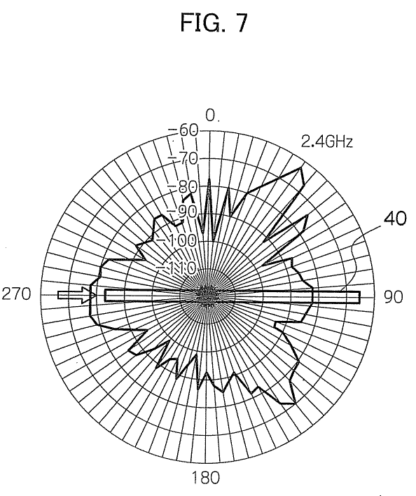

FIG. 7 shows the measurement result of the directivity of a LCX (a leaky transmission line) at a frequency of 2.4 GHz. In this measurement, as shown in FIG. 7, a LCX40 having a length of one meter was placed in a horizontal position and was rotated, and the directivity of the LCX40 was measured with a standard dipole antenna placed three meters away from the LCX40.

FIG. 7 shows that the 10 dB down angle of the maximum radiation power of the LCX40 is 15 degrees. Thus, it is natural that the measurement result shown in FIG. 6(B) was obtained.

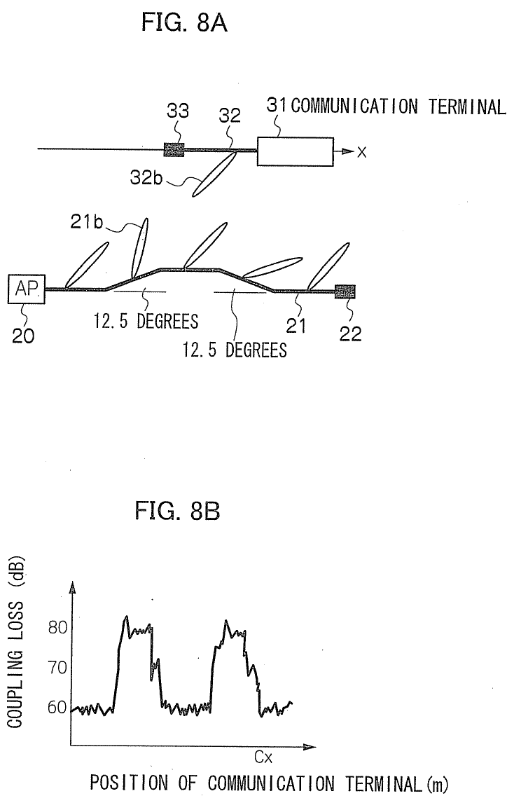

FIG. 8(A) shows a case where the parallelism between the leaky transmission lines 21 and 32 is further degraded. FIG. 8(A) shows a case where only a displacement of 12.5 degrees occurs partly with respect to the parallelism. FIG. 8(B) shows the measurement result of the coupling loss with respect to the position of the communication terminal 31 in this case. FIG. 8(B) shows that in the portions where the parallelism is degraded, the coupling loss is increased by about 20 dB, that is, the quality of the communications is degraded. FIG. 7 shows that the 20 dB down angle of the maximum radiation power of the LCX40 is 25 degrees. Thus, it is natural that the measurement result shown in FIG. 8(B) was obtained.

The coupling loss is preferably small. However, this is impossible due to an accuracy with which the leaky transmission line (LCX) is laid, an attenuation by the leaky transmission line itself, connection loss between the leaky transmission line and a connector or the like. It is generally thought that stable communications are possible as long as rapid variations in coupling loss fall within about 10 dB. Thus, in the first embodiment, the term “parallel” means that the displacement of angle falls within 7.5 degrees with respect to parallelism.

According to the first embodiment, even when a leaky transmission line connected to a wireless base station includes a curved portion or the like and thus includes a portion that is not parallel to the movement path of a moving object, there are provided a leaky transmission line that effectively functions in communications as an antenna for a mobile communication terminal when it is parallel to the leaky transmission line connected to the wireless base station and a transmit/receive antenna that effectively functions in communications when the leaky transmission line for the mobile communication terminal is not parallel to the leaky transmission line connected to the wireless base station. Thus, it is possible to ensure satisfactory communications between the wireless base station and the communication terminal without a complicated configuration of the system but by a simple process to build the system.

That is, unlike the technology disclosed in Japanese Patent Laid-open No. 04-230131, to ensure satisfactory communications between the wireless base station and the communication terminal, it is possible to simplify the system configuration without any additional component being provided in the leaky transmission line connected to the wireless base station. This also makes it unnecessary to switch the directivity direction of the mobile communication terminal.

### (B) A Second Embodiment

A communication terminal and a mobile communication system according to a second embodiment of the present invention will now be described below with reference to the accompanying drawings.

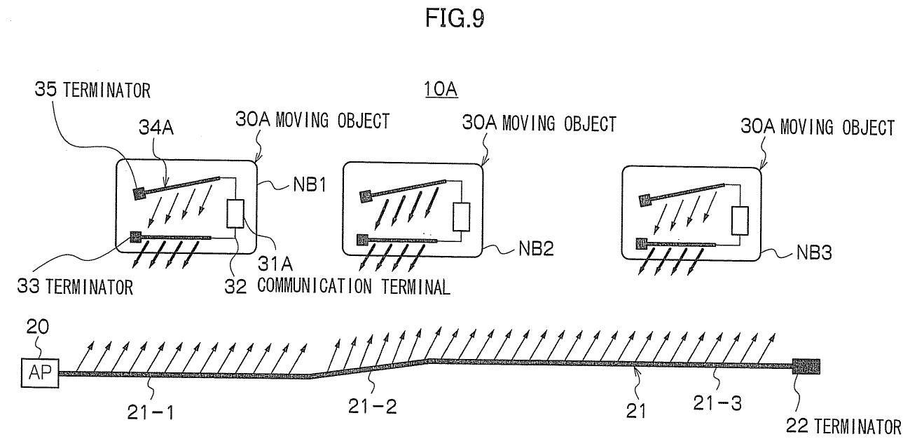

FIG. 9 shows the configuration of the mobile communication system of the second embodiment. In FIG. 9, the same parts as those found in FIG. 1 of the first embodiment are identified with common reference numerals and the corresponding parts are identified with the corresponding reference numerals.

In FIG. 9, the mobile communication system 10A of the second embodiment also has a wireless base station 20 and a moving object 30A but differs in the internal configuration of the moving object 30A from that of the first embodiment.

The moving object 30A of the second embodiment has a leaky transmission line 34A instead of the transmit/receive antenna 34 of the first embodiment, and the leaky transmission line 34A is terminated by a terminator 35.

The leaky transmission line 34A extends so as to be parallel to the intermediate leaky transmission line portion 21-2 of the leaky transmission line 21 connected to the wireless base station 20. However, the leaky transmission line 34A cannot be parallel to the leaky transmission line portions 21-1 and 21-3 of the leaky transmission line 21 connected to the wireless base station 20.

Thus, in the second embodiment, when the moving object 30A is positioned in the vicinity NB2 of the second portion 21-2 of the leaky transmission line 21, the radiation direction of the leaky transmission line 34A of the moving object 30A faces opposite that of the second portion 21-2, and therefore the coupling between the second portion 21-2 and the leaky transmission line 34A functions more effectively.

According to the second embodiment, since the moving object 30A has, instead of the transmit/receive antenna 34, the leaky transmission line 34A serving to function similarly to the antenna, it is possible to obtain the same benefits as those of the first embodiment.

### (C) A Third Embodiment

A communication terminal and a mobile communication system according to a third embodiment of the present invention will now be described below with reference to the accompanying drawings.

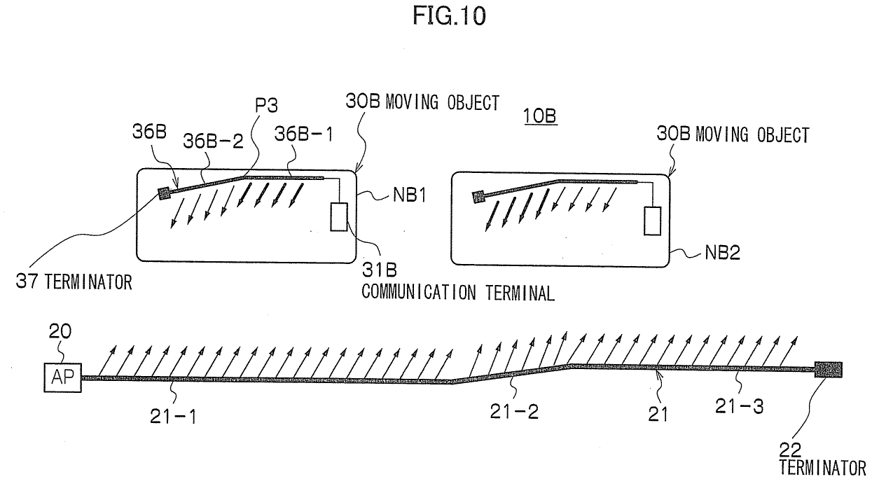

FIG. 10 shows the configuration of the mobile communication system of the third embodiment. In FIG. 10, the same parts as those found in FIG. 9 of the second embodiment are identified with common reference numerals and the corresponding parts are identified with the corresponding reference numerals.

In FIG. 10, the mobile communication system 10B of the third embodiment also has a wireless base station 20 and a moving object 30B but differs in the internal configuration of the moving object 30B from those of the previously described embodiments.

As will be obvious from the comparison between FIGS. 9 and 10, in the moving object 30B of the third embodiment, one leaky transmission line 36B extends from a communication terminal 31B and is terminated by a terminator 37. In the third embodiment, since only one leaky transmission line 36B extends from the communication terminal 31B, no diversity circuit is provided inside the communication terminal 31B.

The leaky transmission line 36B has one bent point P3, and the portion 36B-1 closer from the bent point P3 to the communication terminal 31B and the portion 36B-2 closer from the bent point P3 to the terminator 37 extend in different directions. The portion 36B-1 extends so as to be parallel to the leaky transmission line portions 21-1 and 21-3 of the leaky transmission line 21 connected to the wireless base station 20. The portion 36B-2 extends so as to be parallel to the intermediate leaky transmission line portion 21-2 of the leaky transmission line 21 connected to the wireless base station 20.

Thus, in the third embodiment, when the moving object 30B is positioned in the vicinity NB1 of the first portion 21-1 of the leaky transmission line 21 or is positioned in the vicinity of the third portion 21-3 of the leaky transmission line 21 (the latter case is unillustrated), in the moving object 30B, the leaky transmission line portion 36B-1 whose radiation direction faces opposite the radiation direction of the leaky transmission line portions 21-1 and 21-3 functions effectively.

When the moving object 30B is positioned in the vicinity NB2 of the second portion 21-2 of the leaky transmission line 21, in the moving object 30B, the leaky transmission line portion 36B-2 whose radiation direction faces opposite the radiation direction of the leaky transmission line portion 21-2 functions effectively.

In the second embodiment, a plurality of leaky transmission lines 32 and 34 connected to the communication terminal 31A are provided in parallel such that their radiation directions face opposite the leaky transmission line portions having different extension directions in the leaky transmission line 21 connected to the wireless base station 20. In contrast, in the third embodiment, a plurality of leaky transmission lines 36B-1 and 36B-2 connected to the communication terminal 31A are linearly provided such that their radiation directions face opposite the leaky transmission line portions having different extension directions in the leaky transmission line 21 connected to the wireless base station 20. However, according to the third embodiment, it is possible to obtain the same benefits as those of the second embodiment.

### (D) A Fourth Embodiment

A communication terminal and a mobile communication system according to a fourth embodiment of the present invention will now be described below with reference to the accompanying drawings.

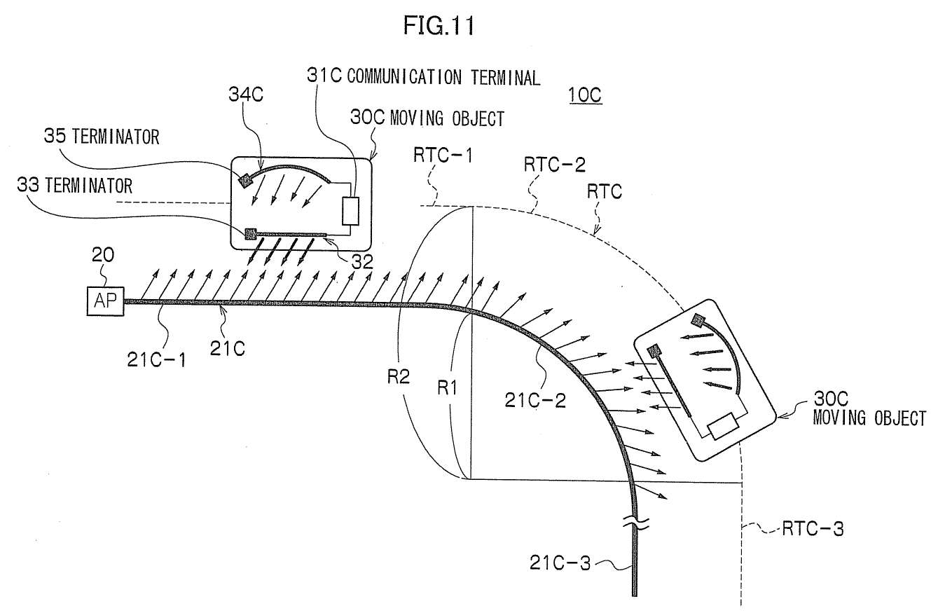

FIG. 11 shows the configuration of the mobile communication system of the fourth embodiment. In FIG. 11, the same parts as those found in FIG. 9 of the second embodiment are identified with common reference numerals and the corresponding parts are identified with the corresponding reference numerals.

In FIG. 11, the mobile communication system 10C of the fourth embodiment also has a wireless base station 20 and a moving object 30C.

The mobile communication system 10C of the fourth embodiment differs from that of the second embodiment in the shape of an laid leaky transmission line 21C extending from the wireless base station 20 and the internal configuration of the moving object 30C.

The leaky transmission line 21C is divided into three portions: a first portion 21C-1 that extends linearly from the wireless base station 20; a second portion 21C-2 that is continuous from the first portion 21C-1 and that has a radius (a radius of curvature) of R1, a central angle of π/2 and an arc shape; and a third portion 21C-3 that is continuous from the second portion 21C-2 and that extends linearly. The second portion 21C-2 may have any shape other than the arc shape.

The movement path RTC of the moving object 30C is also divided into: linear portions RTC-1 and RTC-3 that are parallel to the leaky transmission line portions 21C-1 and 21C-3, respectively, of the leaky transmission line 21C; and an arc-shaped portion RTC-2 that is parallel to the leaky transmission line portion 21C-2 and that has a radius (a radius of curvature) of R2. For example, a rail (a guiding path) is installed for the movement path RTC, and the direction in which the moving object 30C moves changes naturally by the guiding of the rail.

The moving object 30C of the fourth embodiment has a leaky transmission line 32 that faces opposite the radiation direction of the linear portions 21C-1 and 21C-3 of the leaky transmission line 21C and a leaky transmission line 34C that faces opposite the radiation direction of the arc-shaped portion 21C-2 of the leaky transmission line 21C such that they are in parallel.

The curved shape of the leaky transmission line 34C is selected such that when the moving object 30C is positioned in the vicinity of the arc-shaped portion 21C-2 of the leaky transmission line 21C, a displacement between the directivity direction (the direction of the radiation) of the leaky transmission line 34C and the directivity direction of the arc-shaped portion 21C-2 of the leaky transmission line 21C falls within the above-mentioned ±7.5 degrees which is regarded as parallel. For example, the leaky transmission line 34C is formed in an arc shape having a radius (R1+R2)/2.

The fourth embodiment is the same as the second embodiment except the above-described points. According to the fourth embodiment, it is also possible to obtain the same benefits as those of the second embodiment. According to the fourth embodiment, it is possible to handle a case where the leaky transmission line 21C extending from the wireless base station 20 has an arc shape.

### (E) A Fifth Embodiment

A communication terminal and a mobile communication system according to a fifth embodiment of the present invention will now be described below with reference to the accompanying drawings.

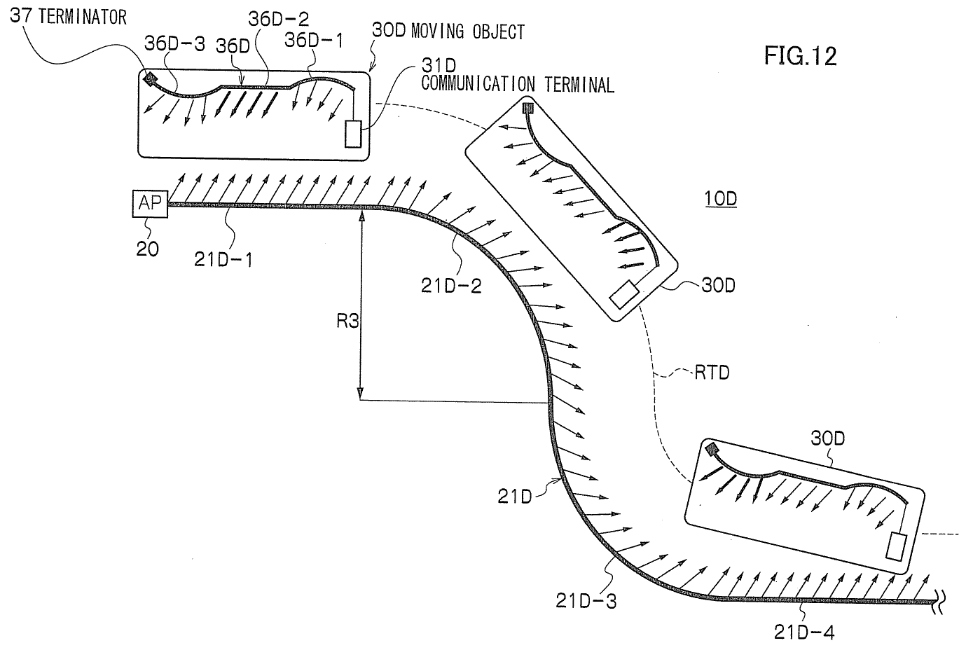

FIG. 12 shows the configuration of the mobile communication system of the fifth embodiment. In FIG. 12, the same parts as those found in FIG. 10 of the third embodiment are identified with common reference numerals and the corresponding parts are identified with the corresponding reference numerals.

In FIG. 12, a leaky transmission line 21D is divided into four portions: a first portion 21D-1 that extends linearly from a wireless base station 20; a second portion 21D-2 that is continuous from the first portion 21D-1 and that has a radius (a radius of curvature) of R3, a central angle of π/2 and an arc shape; a third portion 21D-3 that is continuous from the second portion 21D-2 and that has a radius (a radius of curvature) of −R3, a central angle of π/2 and an arc shape; and a fourth portion 21D-4 that is continuous from the third portion 21D-3 and that extends linearly.

The movement path RTD of a moving object 30D is selected so as to be parallel to the leaky transmission line 21D. The moving object 30C of the fifth embodiment has a leaky transmission line 36D in which a leaky transmission line portion 36D-2 that faces opposite the radiation direction of the linear portions 21D-1 and 21D-04 of the leaky transmission line 21D, a leaky transmission line portion 36D-1 that faces opposite the radiation direction of one of the arc-shaped portions 21D-2 of the leaky transmission line 21D and a leaky transmission line portion 36D-3 that faces opposite the radiation direction of the other arc-shaped portion 21D-3 of the leaky transmission line 21D are connected in series. The shapes of the leaky transmission line portions 36D-1, 36D-2 and 36D-3 are selected such that when the moving object 30D is positioned in the vicinity of the portions that face opposite the radiation direction of the leaky transmission line 21D, a displacement falls within ±7.5 degrees, which is regarded as parallel and makes it possible for them to face opposite each other. This makes it possible to achieve effective communications.

According to the fifth embodiment, it is also possible to obtain the same benefits as those of the third embodiment.

### (F) A Sixth Embodiment

A communication terminal and a mobile communication system according to a sixth embodiment of the present invention will now be described below with reference to the accompanying drawings.

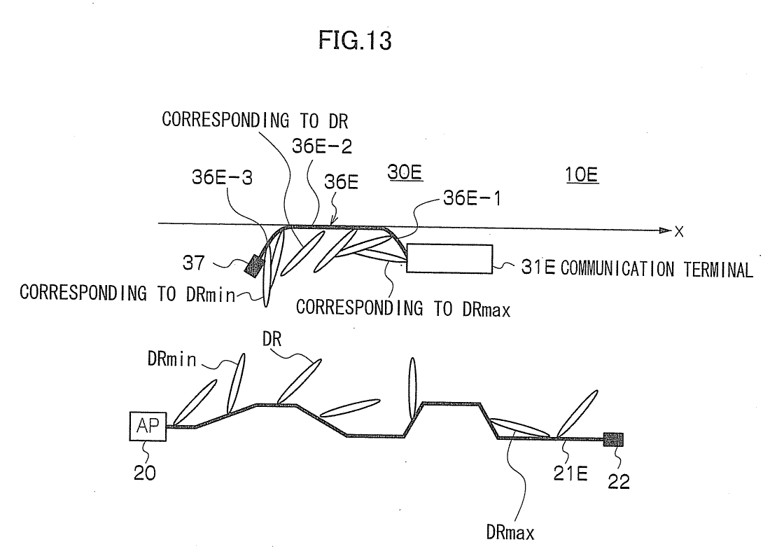

FIG. 13 shows the configuration of the mobile communication system of the sixth embodiment. In FIG. 13, the same parts as those found in FIG. 10 of the third embodiment are identified with common reference numerals and the corresponding parts are identified with the corresponding reference numerals.

In FIG. 13, a leaky transmission line 21E extending from the wireless base station 20, for example, is intended to be laid linearly but is laid to include various projections and depressions with respect to a standard linear shape in order to, for example, bypass obstructions. Thus, in regard to the directivity direction (the direction of the radiation), the leaky transmission line 21E has not only the directivity direction DR of the linear portion but also the directivity direction displaced more from the directivity direction DR of the linear portion and the directivity direction displaced less from the directivity direction DR of the linear portion. In FIG. 13, a directivity direction DRmax represents the maximum value among the directions of the directivity displaced more from the directivity direction DR of the linear portion, and a directivity direction DRmin represents the minimum value (the directivity direction displaced least) among the directions of the directivity displaced less from the directivity direction DR of the linear portion.

In sixth embodiment, a moving object 30E moves parallel to the standard straight line of the leaky transmission line 21E extending from the wireless base station 20.

The leaky transmission line 36E of the moving object 30E has a portion 36E-1 that faces opposite the directivity direction displaced more from the directivity direction DR of the linear portion of the leaky transmission line 21E, a portion 36E-2 that faces opposite the directivity direction DR of the linear portion of the leaky transmission line 21E and a portion 36E-3 that faces opposite the directivity direction displaced less from the directivity direction DR of the linear portion of the leaky transmission line 21E.

In order to have portions that face opposite directivity directions ranging from the maximum directivity direction DRmax to the directivity direction DR of the linear portion, the leaky transmission line portion 36E-1 has a curved shape whose radius of curvature gradually varies from a radius of curvature for achieving the directivity direction facing opposite the maximum directivity direction DRmax (or slightly greater directivity direction than this directivity direction) to a radius of curvature for achieving the directivity direction facing opposite the directivity direction DR of the linear portion.

In order to have portions that face opposite directivity directions ranging from the directivity direction DR of the linear portion to the minimum directivity direction DRmin, the leaky transmission line portion 36E-3 has a curved shape whose radius of curvature gradually varies from a radius of curvature for achieving the directivity direction facing opposite the directivity direction DR of the linear portion to a radius of curvature for achieving the directivity direction facing opposite the minimum directivity direction DRmin (or slightly smaller directivity direction than this directivity direction).

Thus, even when the moving object 30E moves, the directivity direction of the leaky transmission line 21E positioned in the vicinity of the moving object 30E varies from the maximum directivity direction DRmax to the minimum directivity direction DRmin, any portion of the leaky transmission line 36E of the moving object 30E faces opposite the leaky transmission line 21E. This makes it possible to perform communications effectively.

As described above, according to the sixth embodiment, it is also possible to obtain the same benefits as those of the third embodiment.

### (G) A Seventh Embodiment

A communication terminal and a mobile communication system according to a seventh embodiment of the present invention will now be described below with reference to the accompanying drawings.

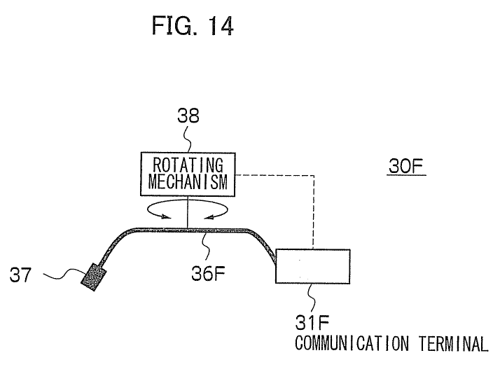

The configuration of a moving object 30F of the seventh embodiment differs from that of the sixth embodiment. FIG. 14 is an illustrative diagram schematically showing the configuration of the moving object 30F according to the seventh embodiment. Since the configuration of a wireless base station is the same as that of the sixth embodiment, the reference numerals in FIG. 13 are used in the seventh embodiment.

Preferably, the plane in which the leaky transmission line 36F of a moving object 30F is laid and the plane in which a leaky transmission line 21E extending from a wireless base station 20 is laid are the same flat plane. However, in reality, the leaky transmission line 21E extending from the wireless base station 20 is highly likely to bend in all directions. Although in FIG. 13, the leaky transmission line 21E extending from the wireless base station 20 bends in the plane of the figure, it may bend in a direction perpendicular to the plane of the figure.

In view of the foregoing, in the seventh embodiment, the moving object 30F is provided with a rotating mechanism 38 for the leaky transmission line 36F and thus a communication terminal 31F can control the rotation of the rotating mechanism 38 (the leaky transmission line 36F may be rotated together with the communication terminal 31F). For example, the communication terminal 31F slightly rotates the leaky transmission line 36F back and forth to search for the maximum value of the received level. By repeating such a control operation, the received level is satisfactorily controlled all the time.

According to the seventh embodiment, the moving object is provided with the rotating mechanism for the leaky transmission line and this makes it possible to search for the rotation position suitable for a satisfactory directivity direction. Thus, more stable communications than those of the embodiments described above can be expected.

### (H) Other Embodiments

The present invention is not limited to the embodiments described above, and variations described below as examples are possible.

The technical ideas of the above-described embodiments may be combined together. For example, the technical idea of the seventh embodiment may be combined with the technical idea of any other embodiment.

Although the above embodiments deal with the case where the wireless base station is fixed, the wireless base station of the above embodiments may be movable and the moving object of the above embodiments may be fixed. Both the wireless base station and the moving object of the above embodiments may be movable.

Although the above embodiments deal with the case where one leaky transmission line extends from the wireless base station, the present invention can apply to the case where leaky transmission lines extend from the wireless base station in right and left directions. In this case, for example, the moving object is configured such that the leaky transmission line extends from the communication terminal in right and left directions and faces opposite the radiation direction of each leaky transmission line connected to the wireless base station.

Although it is assumed in the above embodiments that the leaky transmission line extending from the wireless base station is of the same type as the leaky transmission line connected to the wireless base station, they may differ in diameter or the like as long as the radiation directions are the same (parallel to each other).

Although the seventh embodiment deals with the case where the moving object is provided with one rotating mechanism, the moving object may be provided with two or more rotating mechanisms and they may be rotated about a plurality of rotation axes. For example, a rotating mechanism that rotates about a rotation axis extending in the direction of the normal to the plane of FIG. 14 may be added. Moreover, the leaky transmission line of the moving object may be attached to an x, y, θ stage, an x, y, z, θ stage or the like so that it can not only rotate but also moves in parallel.

In the case where as shown in FIG. 11, the moving object moves while changing the direction in which it moves, the direction in which the moving object moves may be changed by the above-described rotating mechanism. For example, the control of such a direction by the rotating mechanism is effective when the moving object is hung from a rail attached on a ceiling.

Although in the description of the above embodiments, the leaky transmission line portion of the moving object (or the transmit/receive antenna) that faces opposite the radiation direction of one portion of the leaky transmission line extending from the wireless base station is not parallel to other portions of the leaky transmission line extending from the wireless base station, such a portion may be parallel to the other portions.

Although the above embodiments deal with the case where a plurality of leaky transmission line portions are connected to the communication terminal in series or in parallel, they may be connected in series and in parallel in combination. For example, when there are four leaky transmission line portions in the moving object, two portions may be connected in series and the remaining two portion may also be connected in series and then these two series may be connected in parallel to the communication terminal.

What is claimed is:

1. A communication terminal for communicating with a base station that has, as an antenna, a leaky transmission line including a curved portion in at least a part thereof or a leaky transmission line including two linear portions extending in different directions in at least a part thereof,
wherein the communication terminal relatively moves in parallel to the leaky transmission line of the base station, and the communication terminal has a leaky transmission line whose radiation direction faces opposite a radiation direction of a part or a whole of the leaky transmission line of the base station, as at least a part of an antenna element, connected to the communication terminal.

2. The communication terminal of claim 1,
wherein when a difference in angle between the radiation directions falls within the range between 180±7.5 degrees, the radiation directions are considered to face opposite each other.

3. The communication terminal of claim 1,
wherein a direction in which the leaky transmission line of the communication terminal extends coincides with an angle at which a part of the leaky transmission line of the base station is laid, the radiation direction of the part facing opposite the radiation direction of the communication terminal.

4. The communication terminal of claim 1,
wherein a radius of curvature of the leaky transmission line of the communication terminal is approximately equal to a radius of curvature of a part of the leaky transmission line of the base station, the radiation direction of the part facing opposite the radiation direction of the communication terminal.

5. The communication terminal of claim 1, further comprising:
a non-leaky antenna element formed with an antenna element other than a leaky transmission line.

6. The communication terminal of claim 1,
wherein the communication terminal includes selection means that selectively activates one of a plurality of the antenna elements that are connected in parallel to the communication terminal.

7. The communication terminal of claim 1,
wherein the communication terminal includes combination means that combines signals received from a plurality of the antenna elements that are connected in parallel to the communication terminal and that are formed with the antenna element.

8. The communication terminal of claim 1,
wherein a part facing opposite the radiation direction of the leaky transmission line of the base station includes a plurality of different leaky transmission lines of the communication terminal.

9. The communication terminal of claim 8,
wherein the plurality of leaky transmission lines of the communication terminal are connected in parallel to the communication terminal.

10. The communication terminal of claim 8,
wherein a series obtained by connecting in series the plurality of leaky transmission lines of the communication terminal are connected to the communication terminal.

11. The communication terminal of claim 1,
wherein a whole or a part of the leaky transmission lines of the communication terminal is connected to a rotating mechanism.

12. A mobile communication system, comprising:
a first communication terminal that has, as an antenna, a leaky transmission line including a curved portion in at least a part thereof or a leaky transmission line including two linear portions extending in different directions in at least a part thereof; and
a second communication terminal that relatively moves in parallel to the leaky transmission line of the first communication terminal, that communicates with the first communication terminal and that has a leaky transmission line whose radiation direction faces opposite a radiation direction of a part or a whole of the leaky transmission line of the first communication terminal, as at least a part of an antenna element, connected to the communication terminal.
